(19) United States
(12) Patent Application Publication
(10) Pub. No.: US 2013/0105522 A1
(43) Pub. Date: May 2, 2013

(54) BULK MATERIAL DISPENSER

(71) Applicant: Bottlecap Holdings Ltd., Vancouver (CA)

(72) Inventors: Bradley Gordon Friesen, Vancouver (CA); Alexander Trampolski, Eastvale, CA (US)

(73) Assignee: Bottlecap Holdings Ltd., Vancouver (CA)

(21) Appl. No.: 13/665,589

(22) Filed: Oct. 31, 2012

Related U.S. Application Data
(60) Provisional application No. 61/554,418, filed on Nov. 1, 2011.

(51) Int. Cl. G01F 11/24

(52) U.S. Cl. 222/361

(57) ABSTRACT

The present disclosure is directed at a bulk material dispenser for dispensing bulk material stored in a container. In one form, the dispenser responds to an axial force applied along its longitudinal axis and dispenses a measured dose of the bulk material. In another form, the dispenser responds to a rotational force applied about its longitudinal axis and dispenses a measured dose of the bulk material. The dispenser includes a doser, which determines the amount of the bulk material to dispense, and a doser cover, which is movable between loading and dispensing positions. When in the loading position, the doser cover is positioned so that the bulk material can enter, but cannot exit, the doser. When in the dispensing position, the doser cover is moved so that the bulk material can exit the doser and be dispensed.

### CROSS REFERENCE TO RELATED APPLICATION

The present application claims the benefit of U.S. Provisional Application No. 61/554,418, filed Nov. 1, 2011, which is incorporated herein by reference.

### TECHNICAL FIELD

The present disclosure is directed at a bulk material dispenser.

### BACKGROUND

People are increasingly purchasing bulk materials such as powdered nutrients and bulk foods. Doing so is economical and, depending on the nature of the bulk material purchased, can also be healthy. For example, significant numbers of people are interested in supplementing their normal diets with vitamins, which can be powdered and distributed in their bulk form. Accordingly, research and development continues into ways in which bulk materials can be conveniently and efficiently dispensed.

### BRIEF DESCRIPTION OF THE DRAWINGS

In the accompanying drawings, which illustrate one or more exemplary embodiments:

FIG. 1 is a top perspective view of a container coupled to a bulk material dispenser, according to a first embodiment.

FIGS. 2(a) and (b) are top and bottom perspective views of the dispenser of FIG. 1.

FIG. 2(c) is a sectional view of the dispenser of FIG. 1, taken along line 2(c)-2(c) of FIG. 2(a).

FIGS. 3(a) to (c) are bottom perspective, front elevation, and right side elevation views of a container cover and doser used in the dispenser of FIG. 1.

FIG. 4(a) is a top perspective view of the container cover used in the dispenser of FIG. 1.

FIGS. 4(b) and (c) are right side and front elevation views of the doser used in the dispenser of FIG. 1.

FIG. 5 is a top perspective view of a retaining collar, stability collar, doser cover, and sealing ring used in the dispenser of FIG. 1.

FIGS. 6(a) to (c) are top perspective, top plan, and bottom plan views of an actuator plate, the stability collar, and the doser cover used in the dispenser of FIG. 1.

FIGS. 7(a) to (c) are top perspective, top plan, and bottom plan views of the retaining collar used in the dispenser of FIG. 1.

FIG. 8(a) is a top perspective view of the bulk material dispenser, according to a second embodiment.

FIG. 8(b) is a top perspective view of the retaining collar used in the dispenser of FIG. 8(a).

FIG. 8(c) is a bottom perspective view of the actuator plate, stability collar, and doser cover used in the dispenser of FIG. 8(a).

FIGS. 9(a) and (b) are top and bottom perspective views of the bulk material dispenser, according to a third embodiment.

FIG. 10(a) is a bottom perspective view of the container and doser covers used in the dispenser of FIG. 9(a).

FIGS. 10(b) and (c) are top plan and top perspective views of the doser used in the dispenser of FIG. 9(a).

FIGS. 11(a) and (b) are top and bottom perspective views of the bulk material dispenser, according to a fourth embodiment.

FIGS. 12(a) and (b) are bottom perspective and bottom plan views of the container and doser covers used in the dispenser of FIG. 11(a).

FIGS. 12(c) and (d) are top perspective and top plan views of the doser, a cylindrical stopper, and a torsion spring used in the dispenser of FIG. 11(a).

### SUMMARY

According to one aspect of the invention, there is provided a bulk material dispenser for dispensing bulk material contained within a container. The dispenser comprises a container cover, a doser, and a doser cover. The container cover is capable of coupling over an opening in the container; the opening allows access to the interior of the container. The doser extends through the cover and has an inlet on a side of the cover that faces the interior of the container when the container cover is coupled to the container, and an outlet on a side of the cover that faces away from the interior of the container when the container cover is coupled to the container. The inlet and outlet are communicatively coupled such that substantially all of the bulk material that passes through the container cover moves from the inlet to the outlet through the doser. The doser cover is movable on the doser between loading and dispensing positions; the doser cover leaves the inlet at least partially uncovered and closes the outlet when in the loading position, and leaves the outlet at least partially uncovered and closes the inlet in the dispensing position.

The container cover can be shaped such that the bulk material is funneled into the inlet of the doser. The container cover can have an elongated rim circumscribing the container cover that is attachable at one end around the opening in the container. The dispenser can further comprise a doser holder coupled to an attachment point on the doser located farther from the container cover than the inlet; and a support arm coupling the container cover to the doser holder.

The doser cover can comprise a sleeve slidable along the length of the doser and between the doser and the support arm, and out of which the outlet extends when the doser cover is in the dispensing position. The dispenser can further comprise an actuator plate coupled to the doser cover, wherein the doser cover extends through the actuator plate and moves along the doser in response to actuation of the actuator plate towards the container cover. The actuator plate can be shaped to form an annular region around a portion of the doser cover that is on a side of the actuator plate that faces away from the interior of the container.

The dispenser can further comprise a compression spring located between the actuator plate and the container cover and be pushed against the container cover by the actuator plate when the actuator plate is actuated. The dispenser can further comprise a retaining collar coupled to an end of the elongated rim opposite the end attachable to the container, wherein the retaining collar comprises a retaining collar flange that supports the actuator plate when the doser cover is in the loading position.

The dispenser can further comprise a stability collar circumscribing the actuator plate and slidable within the coupling and retaining collars in response to the actuation of the actuator plate in which case the support collar rests on the retaining collar flange when the doser cover is in the loading position. The stability collar can further comprise an outwardly projecting support ridge on its exterior, in which case the retaining collar further comprises inwardly projecting flutes, and the support ridge rests on the flutes and the flutes guide the support collar within the retaining collar as the doser cover moves between the loading and dispensing positions.

According to another aspect of the invention, there is provided a bulk material dispenser for dispensing bulk material contained within a container. The dispenser comprises a container cover, a doser, and a doser cover. The container cover is capable of coupling over an opening in the container. The opening allows access to the interior of the container and the container cover comprises a slot that allows the bulk material contained within the container to pass through the cover when the container cover is coupled over the opening. The doser is capable of rotatably coupling to the container and has a measuring chamber with an open top portion and an open side portion; the open top portion is alignable with the slot such that the bulk material passing from the container and through the slot can enter the measuring chamber through the open top portion. The doser cover is rotatable relative to the doser between loading and dispensing positions; the doser cover closes the open side portion when in the loading position and leaves the open side portion at least partially uncovered when in the dispensing position.

The doser can rotate about an axis of rotation, in which case the open side portion faces the axis of rotation such that the bulk material exiting the measuring chamber through the open side portion travels towards the axis of rotation. The open side portion can be shaped as a circular arc whose center is along the axis of rotation. The doser cover can be tubular and has a channel in its side, in which case the channel only overlaps with the open side portion when the doser cover is in the dispensing position. The doser cover can be fixedly coupled to the container cover and be inserted through the center of the doser. The doser cover can be coaxial with the axis of rotation. The measuring chamber can have a bottom portion that is tapered to feed the bulk material from the open top portion to the open side portion. A plurality of measuring chambers can be spaced circumferentially around the doser cover such that the doser cover rotates between the loading and dispensing positions for each of the measuring chambers, in which case the open side portion of each of the measuring chambers is adjacent to the doser cover.

The dispenser can further comprise: a torsion spring wrapped around the doser cover; a spring rotating ridge fixedly coupled to one of the doser and doser cover, and a spring stopping ridge fixedly coupled to the other of the doser and doser cover. The spring rotating and stopping ridges are positioned to contact opposite ends of the torsion spring such that the torsion spring is twisted when the doser cover is in the dispensing position and relaxed when the doser cover is in the loading position. The spring rotating ridge can be fixedly coupled to the doser and the spring stopping ridge can be fixedly coupled to the doser cover.

The spring stopping ridge can comprise part of a cylindrical stopper through which the doser cover is inserted. The cylindrical stopper can comprise: an end face having an opening through which the doser cover is inserted and a protrusion extending into the opening insertable into the slot to prevent relative rotation of the cylindrical stopper and the doser cover; and a side wall attached to the end face and having a channel whose edges comprise the spring stopping ridge.

### DETAILED DESCRIPTION

Directional terms such as “top”, “bottom”, “upwards”, “downwards”, “vertically” and “laterally” are used in the following description for the purpose of providing relative reference only, and are not intended to suggest any limitations on how any article is to be positioned during use, or to be mounted in an assembly or relative to an environment.

Increasingly, people are supplementing their diets with beverages infused with some form of nutrients (“infused beverages”). Such beverages include, for example, water that has dissolved in it vitamins or other antioxidants, and protein drinks. In response to such demand, beverage producers have begun producing and selling infused beverages to consumers.

One problem encountered in producing and selling infused beverages is maintaining the potency of dissolved nutrients. For example, some vitamins and antioxidants oxidize and lose their effectiveness in water over time, which is detrimental to product shelf life. Similarly, some dissolved proteins tend to turn rancid over time. In order to overcome this problem, the nutrients and the liquid can be kept separate until the consumer is ready to drink the infused beverage. For example, the nutrients may be kept separately from the liquid in powdered form such that they can be stored indefinitely. When the consumer is ready to drink the infused beverage, he or she can dispense the powdered nutrients into the liquid and then drink.

The powdered nutrients can conventionally be dispensed in several ways. For example, they may be stored in a jug and scooped out of the jug prior to being mixed. Providing the nutrients in this way can be messy and, particularly when several people are using the same jug, cumbersome.

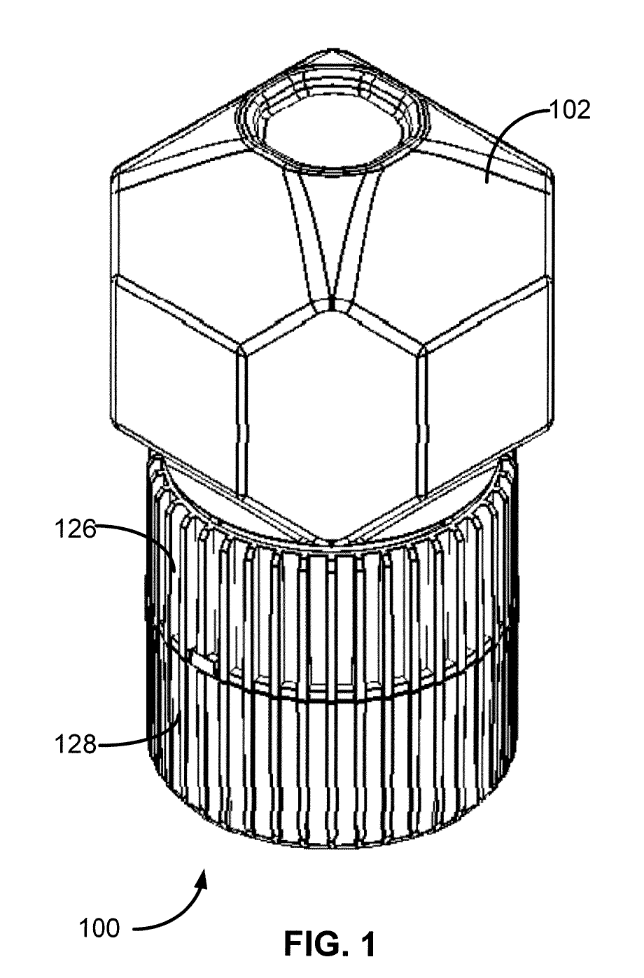

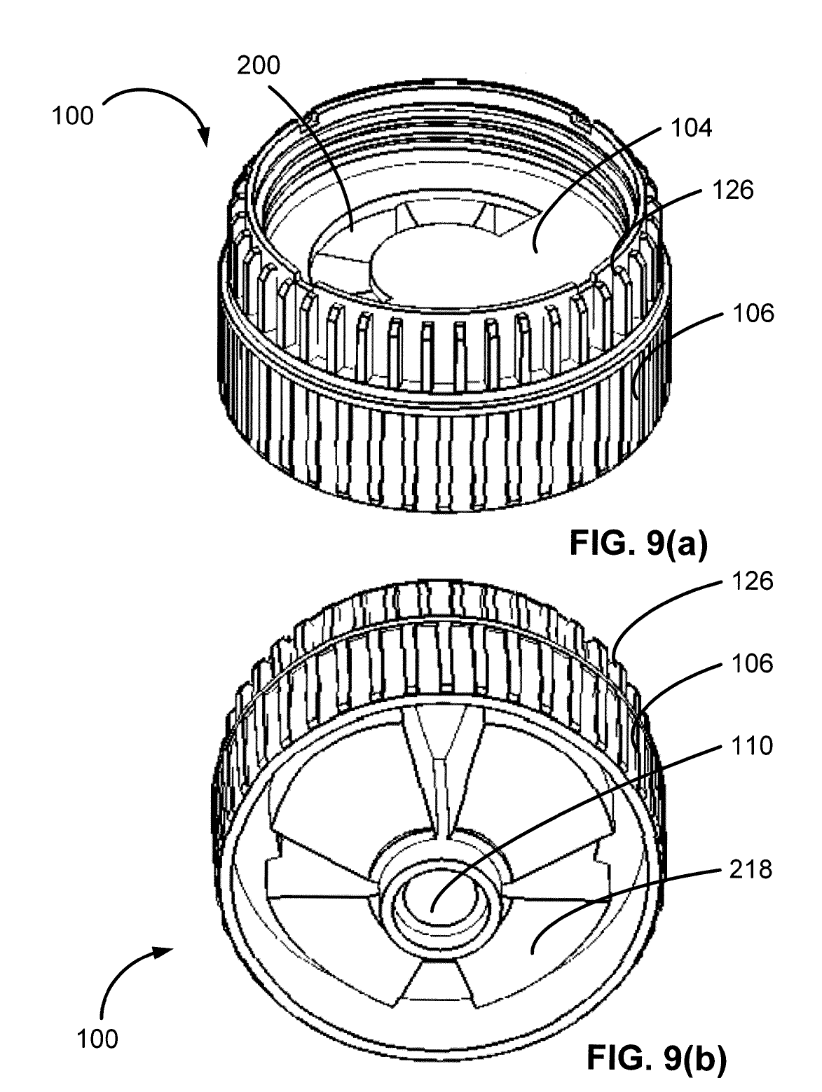

The embodiments described herein are directed at a dispenser 100 for dispensing bulk material, such as powdered nutrients, from a storage container 102. In particular, the following embodiments are for dispensing the bulk material into a bottle or other type of container or receptacle that is positioned under the dispenser 100. FIGS. 1 to 8 depict first and second embodiments of the dispenser 100 in which a bottle (not shown) can be pushed up into the dispenser 100 to dispense the bulk material. FIGS. 9 to 12 depict third and fourth embodiments of the dispenser 100 in which part of the dispenser 100 can be rotated to dispense the bulk material. All of the depicted embodiments allow for measured doses of the bulk material to be relatively quickly and easily dispensed.

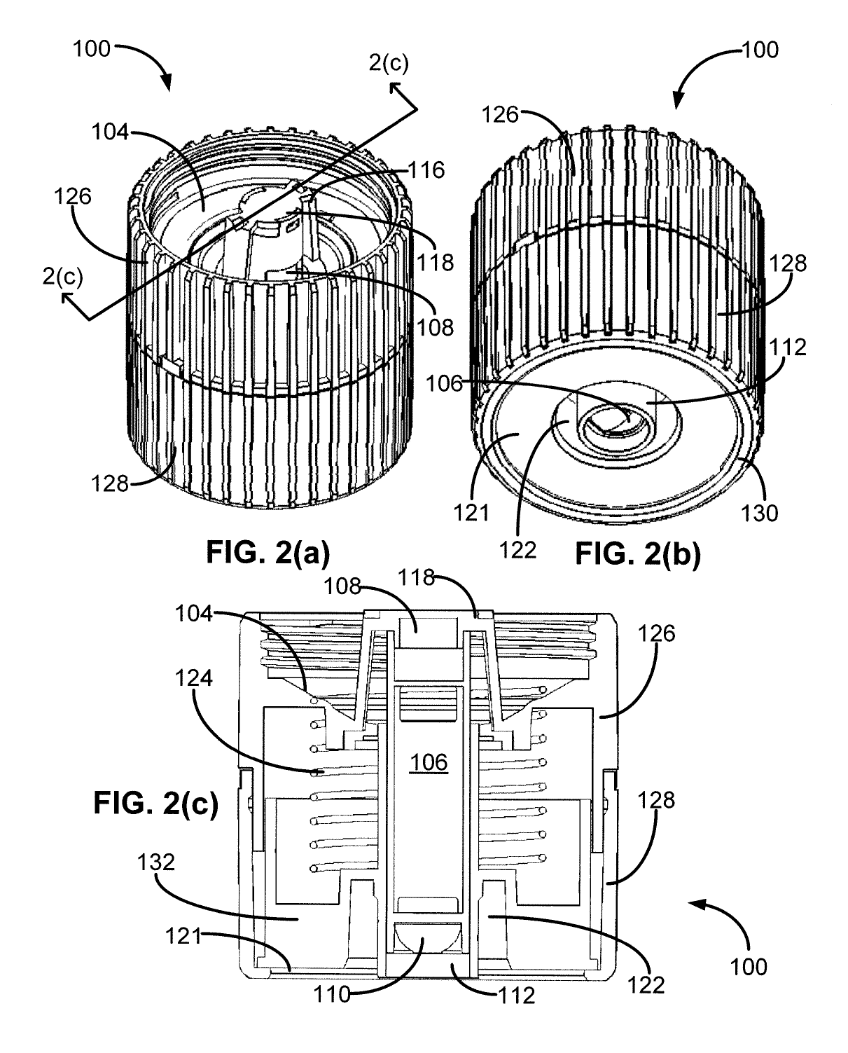

Referring now to FIGS. 1 to 7, there is shown the first embodiment of the dispenser 100. As shown in FIG. 1, which is a perspective view of the dispenser 100 attached to the container 102 that stores the bulk material, the dispenser 100 is designed to fit over an opening in the container 102 through which the bulk material passes as it leaves the container 102. Referring now in addition to FIGS. 2(a) to (c), which respectively show top perspective, bottom perspective, and sectional views of the dispenser 100, the dispenser 100 includes a container cover 104 that has an elongated rim 126. The container cover 104 is positioned between the ends of the rim 126. A portion of the rim 126 that is on a side of the cover 104 that faces towards the interior of the container 102 when the dispenser 100 is attached to the container 102 is threaded and is used to screw the cover 104 on to the container 102. Another portion of the rim 126 that is on the opposite side of the cover 104, which is the side that faces away from the interior of the container 102 when the dispenser 100 is attached to the container 102, is similarly configured to couple to a retaining collar 128, which is discussed in further detail below. Also as discussed in further detail below, the retaining collar 128 is used to retain an actuator plate 121 in place, with axial movement of the actuator plate 121 resulting in the bulk material being dispensed through a hole 117 in the cover 104 and out of the dispenser 100.

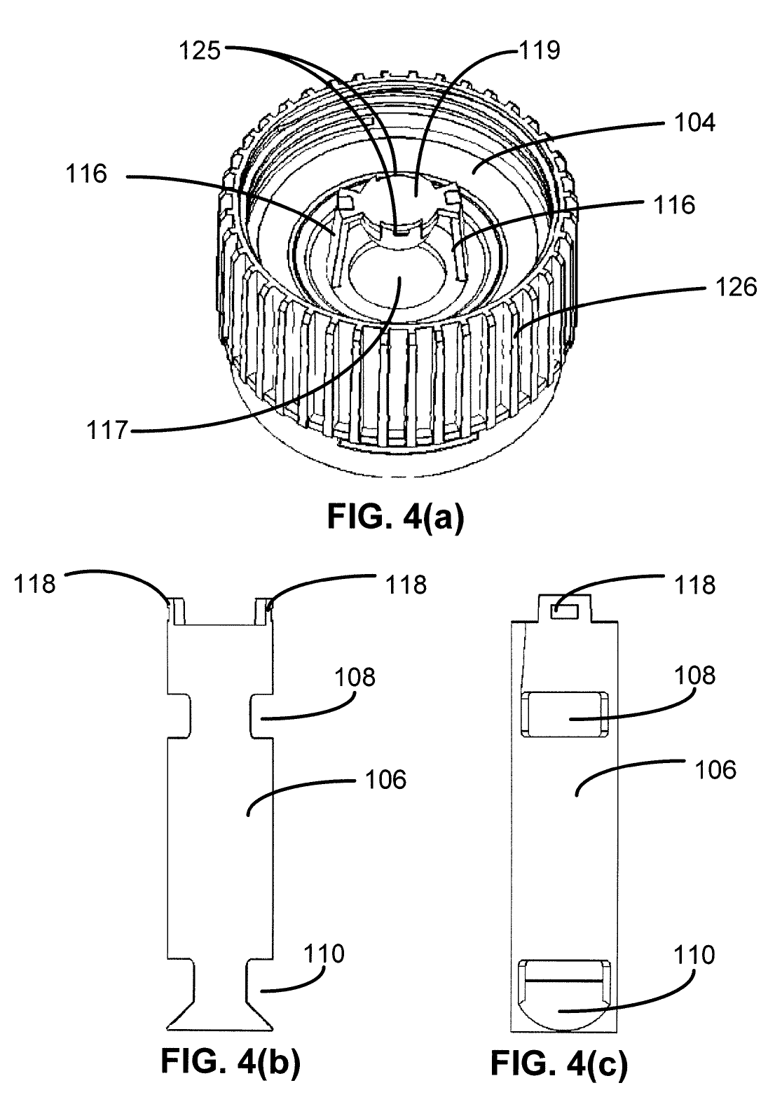

Referring now to FIGS. 4(a) to (c), there is shown a top perspective view of the container cover 104 and side and front elevation views of a doser 106 through which the bulk material is dispensed. The cover 104 is circumscribed by and located between the ends of the rim 126, which has a ribbed exterior to facilitate gripping. Centrally located within the cover 104 is the hole 117 through which the doser 106 is inserted. On either side of the hole 117 are two attachment support arms 116 that support a doser holder 119 over the hole 117. The doser holder 119 has two downwardly extending projections 125 that are shaped to mate with notches 118 on the doser 106 when the doser 106 is secured to the doser holder 119 and extends through the hole 117.

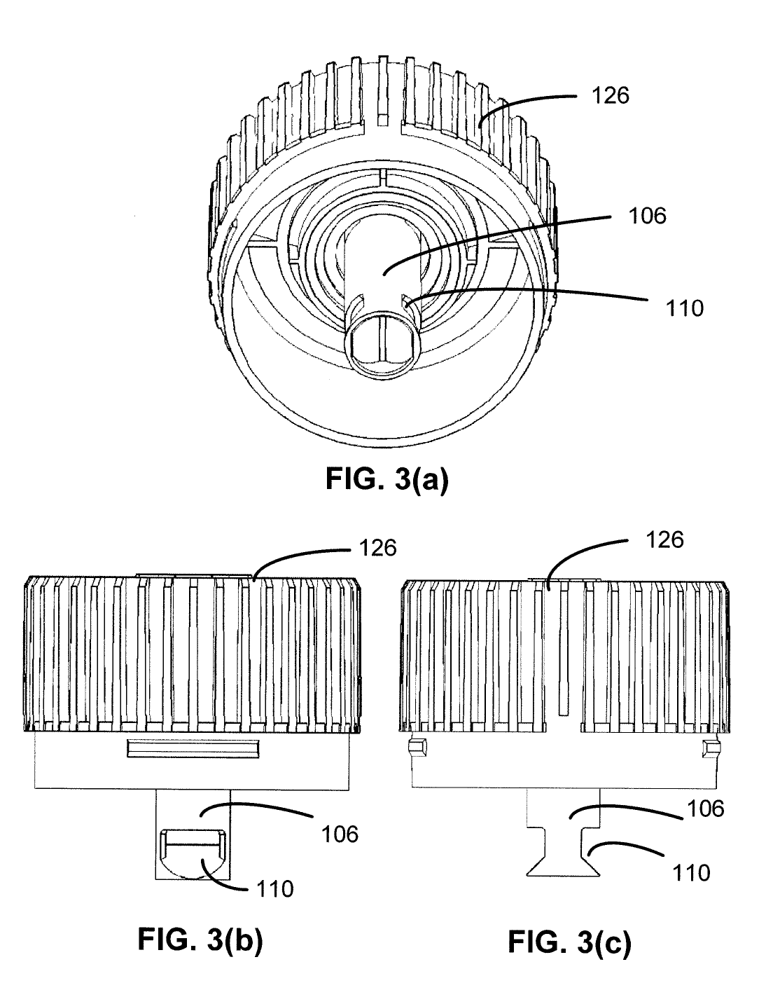

As shown in FIGS. 4(b) and (c), the doser 106 is substantially tubular in shape and is hollow. At the top of the doser 106 are the notches 118 that receive the projections 125 on the doser holder 119 and that operate to suspend the doser 106 in the hole 117. The doser 106 also has an inlet 108 and an outlet 110; by virtue of the doser 106 being hollow, the bulk material can enter the doser 106 through the inlet 108 and exit the doser 106 through the outlet 110. The outlet 110 is tapered to facilitate emptying of the doser 106. When the doser 106 is secured to the doser holder 119, the inlet 106 is on the side of the cover 104 that faces the interior of the container 102 when the dispenser 100 is in use, and the outlet 106 is on the side of the cover 104 that faces away from the interior of the container 102 when the dispenser 100 is in use. As discussed in further detail below, the doser 106 and the hole 117 are sized so that enough space remains between the doser 106 and the hole 117 for a doser cover 120 to slide between them. FIGS. 3(a) to (c) show bottom perspective, front and side elevation views of the container cover 104 and the doser 106 coupled together.

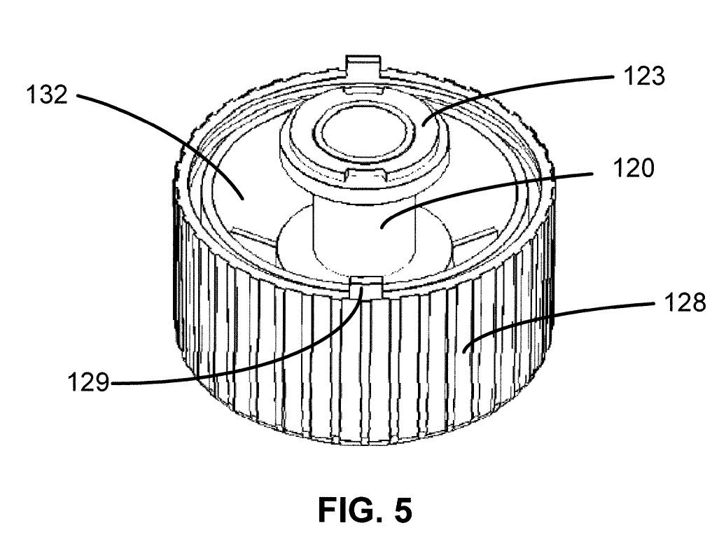

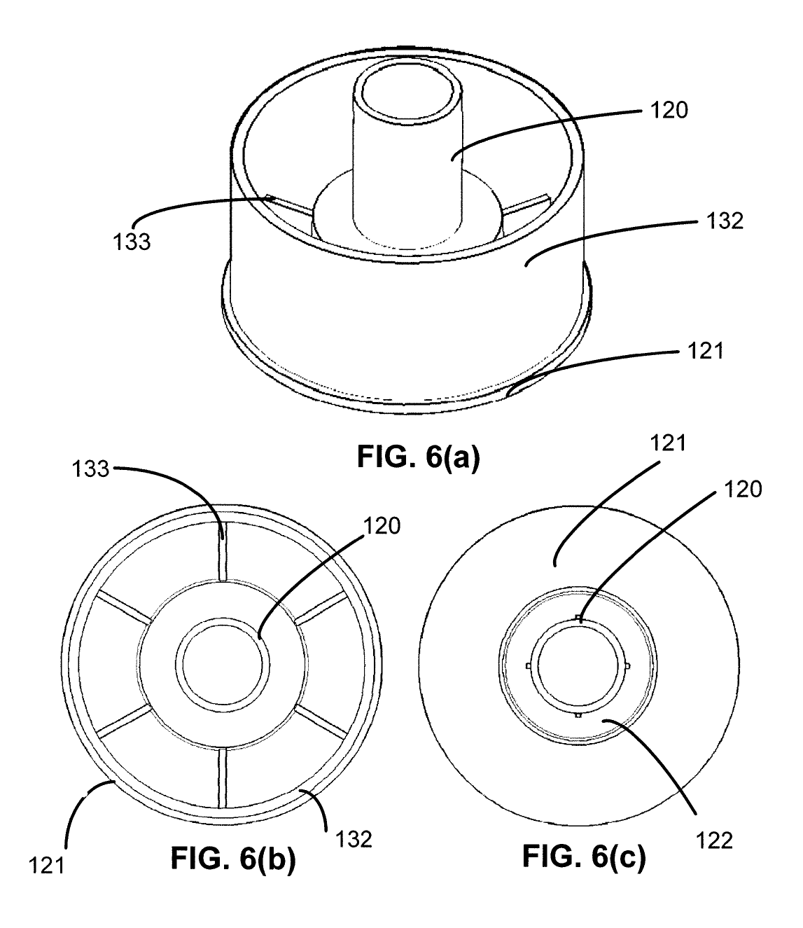

Referring now to FIG. 5, there is shown a top perspective view of the retaining collar 128 having nested within it the doser cover 120, a stability collar 132, and a sealing ring 123. The retaining collar 128 has along its top edge clips 129 that are used to secure the retaining collar 128 to an end of the rim 126 that is opposite the end attachable to the container 102. The doser cover 120 and the stability collar 132 are shown in FIGS. 6(a) to (c) in top perspective, top plan, and bottom plan views. The doser cover 120 is a tubular sleeve with a diameter and wall thickness selected so that it is slidable around the doser 106 and between the doser 106 and the edge of the hole 117. The length of the doser cover 120 is selected so that when it is positioned on the doser 106 to completely cover the inlet 108, it does not cover the outlet 110. Similarly, when the doser cover 120 completely covers the outlet 110, it does not cover the inlet 108.

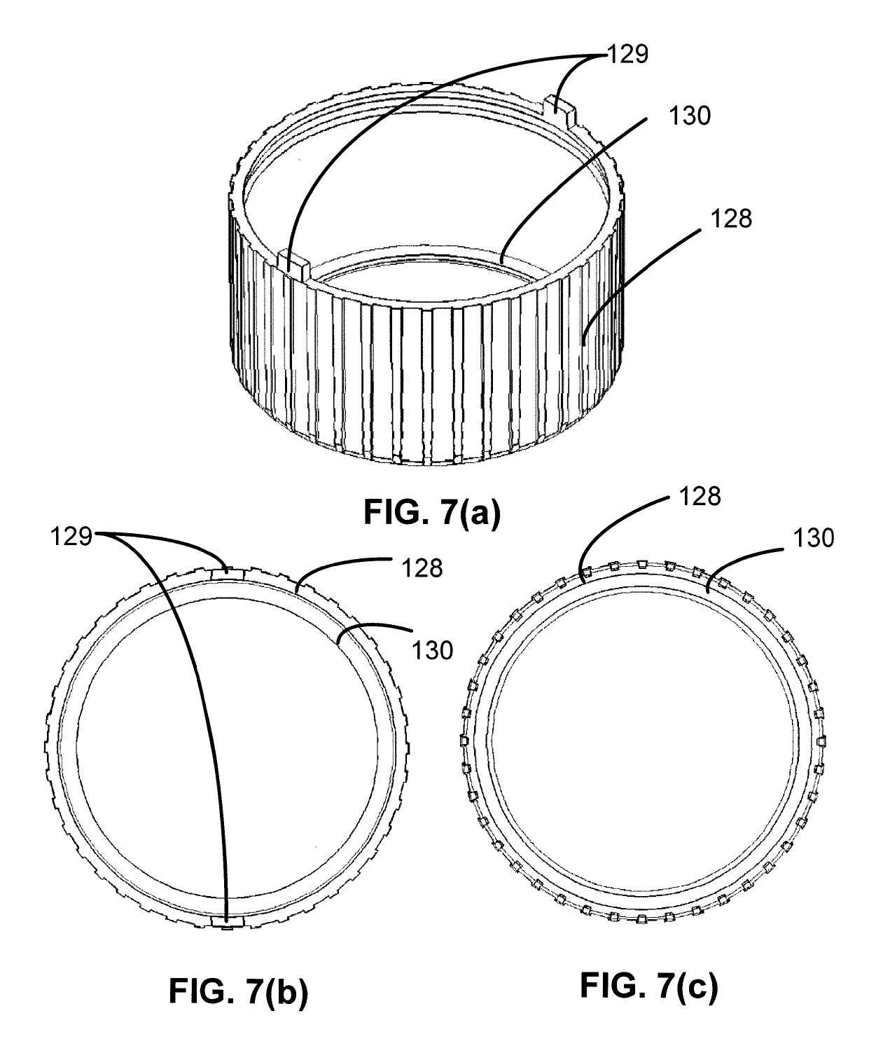

The doser cover 120 is slidable longitudinally along the doser 106, parallel to the longitudinal axis of the dispenser 100. Located at the bottom end of the doser cover 120 is the actuator plate 121, which extends transverse to the longitudinal axis of the doser cover 120. The actuator plate 121 includes an annular region 122 that surrounds a portion of the doser cover 120 and that allows the neck of a bottle to be inserted into it. The actuator plate 121 is slidable along the dispenser 100's longitudinal axis within the retaining collar 128. As highlighted in FIGS. 7(a) to (c), at the bottom of the retaining collar 128 is a retaining collar flange 130 that extends inwards towards the longitudinal axis of the dispenser 100. The actuator plate 121 and the retaining collar flange 130 overlap so that the flange 130 prevents the actuator plate 121 from falling out of the retaining collar 128.

The stability collar 132 is tubular and coaxial with the doser cover 120, and lines the periphery of the actuator plate 121. Radially extending struts 133 extending between the stability collar 134 and the portion of the actuator plate 121 that forms the annular region 122 help the stability collar 132 retain its tubular shape when the dispenser 100 is in use. The stability collar 132 prevents the actuator plate 121 from substantially tilting or pivoting within the retaining collar 128 while it is sliding longitudinally within the retaining collar 128.

When in operation, the container cover 104 and the doser 106 as shown in FIGS. 3(a) to (c) and the retaining collar 128, sealing ring 123, stability collar 132 as shown in FIG. 5 are joined together by snapping together the bottom of the container cover 104's rim 126 to the top of the retaining collar 128. The result is the dispenser as shown in FIGS. 2(a) to (c). As shown in FIGS. 2(a) and (c), the inlet 108 of the doser 106 is on the side of the cover 104 that faces the interior of the container 102. The sealing ring 123 is positioned between the doser 106 and the edge of the hole 117 so that any of the bulk material leaving the container 102 via the dispenser 100 passes through the doser 106. In operation, the doser cover 120 alternates between loading and dispensing positions. When a user is not applying force to the actuator plate 121, a compression spring 124 positioned within the dispenser 100 and between the top of the actuator plate 121 and the bottom of the container cover 104 presses against the actuator plate 121 such that the doser cover 120 covers the outlet 110, and not the inlet 108, of the doser 106; in this position, the doser cover 106 is in the loading position. Consequently, when the dispenser 100 is screwed on to the container 102, the bulk material from the container 102 enters the doser 106 via the inlet 108 and fills the hollow interior of the doser 106. The top of the container cover 104 is shaped like a funnel to direct the bulk material into the inlet 108.

When a user wants to receive a dose of the bulk material, the user can position the bottle under the actuator plate 121 and push the actuator plate 121 upwards towards the container 102. Optionally, the user may position the neck of the bottle into the annular region 122 to prevent the bottle from slipping along the actuator plate 121 while pushing. As the user overcomes the force from the compression spring 124, the doser cover 120 slides upwards along the doser 106 until the inlet 108 of the doser 106 is covered and the outlet 110 of the doser 106 is uncovered; when this occurs, the doser cover 120 is in the dispensing position. The amount of the bulk material that is contained within the doser 106 then falls out of the doser 106 into the bottle. In this way, the dispenser 100 dispenses a particular measured amount of the bulk material.

When the user removes the bottle from the actuator plate 121, the compression spring 124 pushes the actuator plate 121 back against the retaining collar flange 130, consequently returning the doser cover 120 to the loading position. The bulk material again fills the doser 106 through the inlet 108, which prepares the dispenser 100 to release another measured dose of the bulk material the next time the actuator plate 121 is pressed.

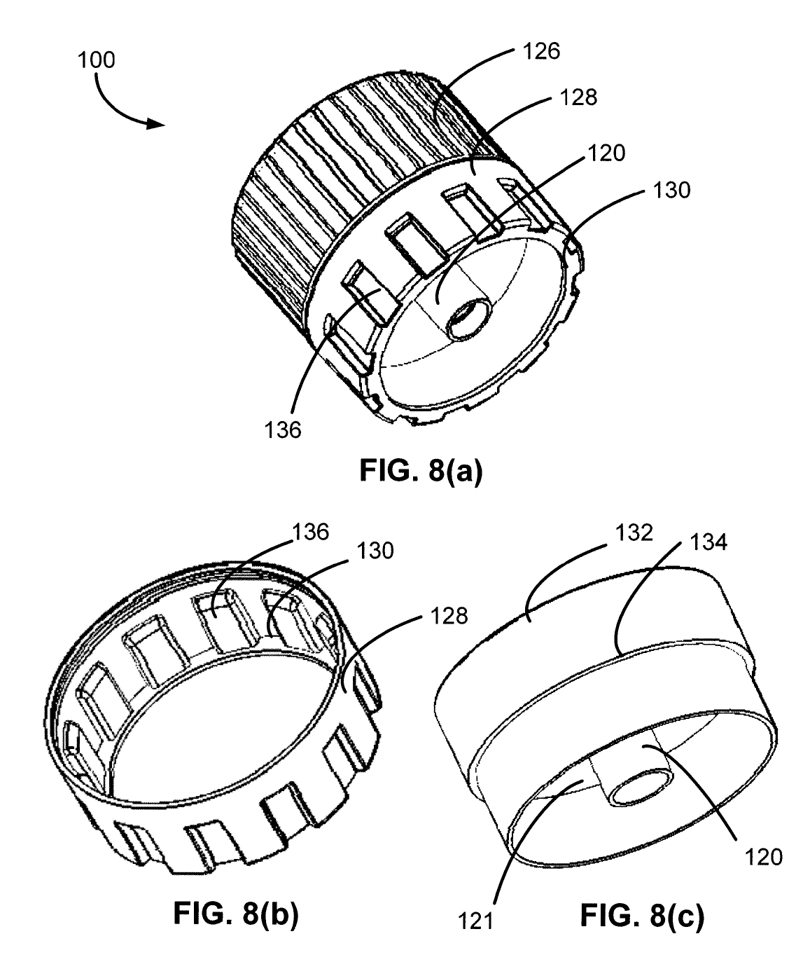

Referring now to FIGS. 8(a) to (c), there is shown the second embodiment of the dispenser 100. The second embodiment of the dispenser 100 is identical to the first embodiment except that it uses a differently shaped retaining collar 128, actuator plate 121, and stability collar 132. In the second embodiment of the dispenser 100, the stability collar 132 includes an outwardly projecting support ridge 134 that is located roughly midway between the stability collar 132's ends, and the actuator plate 121 is coplanar with the support ridge 134. Additionally, the retaining collar 128 has a series of circumferentially spaced, inwardly projecting flutes 136. In addition to the support that the retaining collar 128 provides with the retaining collar flange 130, the support ridge 134 rests on the top surfaces of the flutes 136 when the doser cover 120 is in the loading position, which provides additional support. The annular region 122 around the doser cover 120 in the second embodiment of the dispenser 100 is also larger than that of the first embodiment, as it extends from the doser cover 120 to the edge of the stability collar 132.

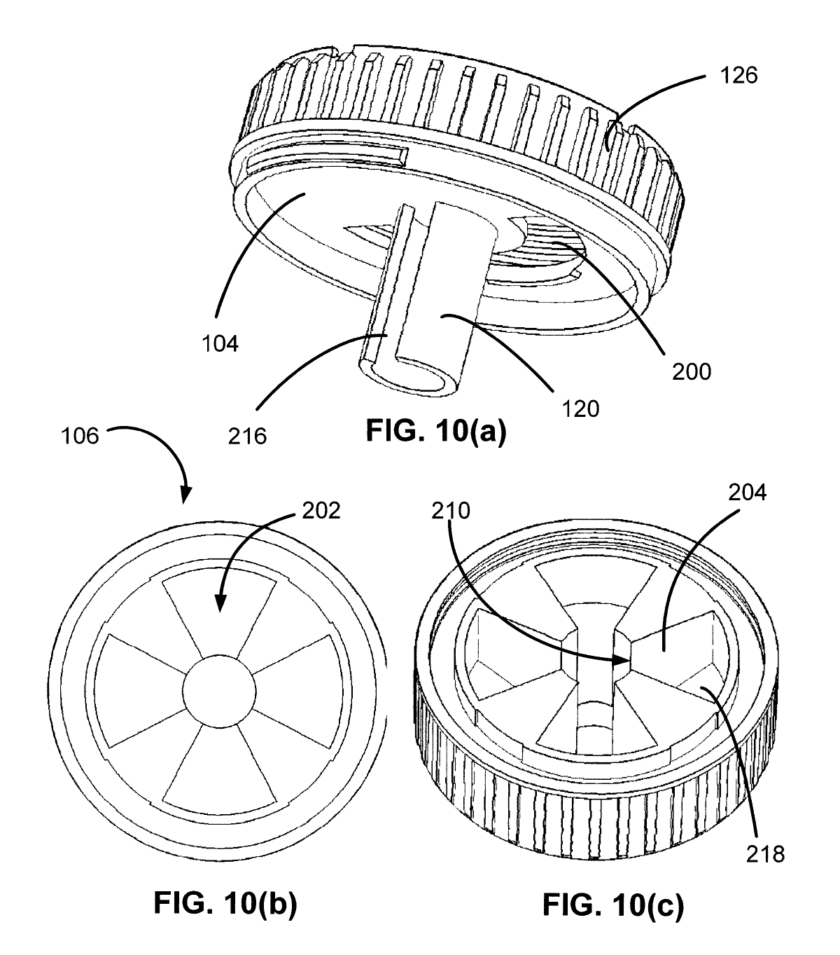

Referring now to FIGS. 9(a) and (b) and 10(a) to (c), there is shown the third embodiment of the dispenser 100. In contrast to the first and second embodiments discussed above, the third embodiment dispenses a measured amount of the bulk material in response to relative rotation of the doser 106 and doser cover 120 about the dispenser 100's axis of rotation, as opposed to relative movement of the doser 106 and doser cover 120 along the dispenser 100's longitudinal axis. In all of the depicted embodiments, the axis of rotation and the dispenser 100's longitudinal axis are collinear, although this may differ in alternative embodiments (not depicted). FIGS. 9(a) and (b) show top and bottom perspective views of the third embodiment of the dispenser 100. As in the first and second embodiments, the third embodiment includes the container cover 104 with the elongated rim 126 for screwing the dispenser 100 on to the container 102. However, in contrast to the first and second embodiments, the doser 106 in the third embodiment does not extend through the cover 104. Instead, the doser 106 is below the cover 104, and the cover 104 has a slot 200 through which the bulk material can pass into the doser 106. As shown in FIGS. 9(b), 10(b), and 10(c), the doser 104 has four measuring chambers 202 into which the bulk material can enter. Each of the measuring chambers 202 is used to measure a particular dose of the bulk material to dispense, and accordingly performs an analogous function as the hollow interior of the tubular doser 106 in the first and second embodiments. Each of the measuring chambers 202 has an open top portion 204 into which the bulk material enters the measuring chambers 202, and an open side portion 210 out of which the bulk material exits the measuring chambers 202, during normal use of the dispenser 100. The slot 200 extends 180 degrees, and consequently allows up to two of the measuring chambers 202 to be simultaneously loaded with the bulk material. Any bulk material exiting the measuring chambers 202 exits through the outlet 110 of the doser 106, which is circular and located in the centre of the doser 106. The open side portion 210 of each of the measuring chambers 202 is shaped as a circular arc having its centre along the axis of rotation of the doser 106, which extends through the centre of the outlet 110. Each of the measuring chambers 202 also has a tapered bottom side to aid in dispensing the bulk material.

Attached to and extending downwards from the container cover 104 is the doser cover 120. The doser cover 120 is tubular and has a channel 216 running along its length. The channel 216 is sized to correspond to the size of the open side portion 210 of each of the measuring chambers 202. During operation of the dispenser 100, the doser 106 is rotatable relative to the doser cover 120 and the container cover 104, which are fixedly coupled to the container 102. Because the channel 216 is only large enough to fit over one of the open side portions 210 at a time, the doser cover 120 is in the dispensing position for only one of the measuring chambers 202 at any one time. The centre of the slot 200 is located 180 degrees from the centre of the channel 216 so that neither of the measuring chambers 202 that is being fed with the bulk material through the slot 200 is simultaneously dispensing the bulk material. During any full rotation of the doser 106, the bulk material falls through the slot 200 in the container cover 104 and enters one of the measuring chambers 202 when the open top portion 204 for that measuring chamber 202 is aligned with the slot 200; when one of the measuring chambers 202 is being filled with the bulk material, the doser cover 120 is in the loading position for that particular measuring chamber 202. For most of the rotation of the doser 106, the open side portion 210 of each of the measuring chambers 202 is covered by the doser cover 120. However, during one portion of every full rotation of the doser 106, the open side portion 210 for each of the measuring chambers 202 is aligned with the channel 216 in the doser cover 120, and the bulk material contained in that measuring chamber 202 exits the measuring chamber 202 via the open side portion, travels through the channel 216 in the doser cover 120, and drops out of the dispenser 100 through the outlet 110 of the doser 106. When the bulk material is exiting the measuring chamber 202 through the channel 216 in the doser cover 120, the doser cover 120 is in the dispensing position for that particular measuring chamber 202.

In the embodiment depicted in FIGS. 9(a) to 10(c), one full rotation of the doser 106 relative to the container cover 104 results in an amount of the bulk material corresponding to four of the measuring chambers 202 being dispensed, while a fraction of a rotation can result in an amount of bulk material corresponding to anywhere from one to four of the measuring chambers 202 being dispensed. However, alternative embodiments of the dispenser 100 may have more or fewer than four of the measuring chambers 202. Additionally, the slot 200 and the channel 216 in alternative embodiments may be differently sized such that more or less than two of the measuring chambers 202 can be simultaneously loaded with the bulk material, and such that the bulk material can be simultaneously dispensed from more than one of the measuring chambers 202.

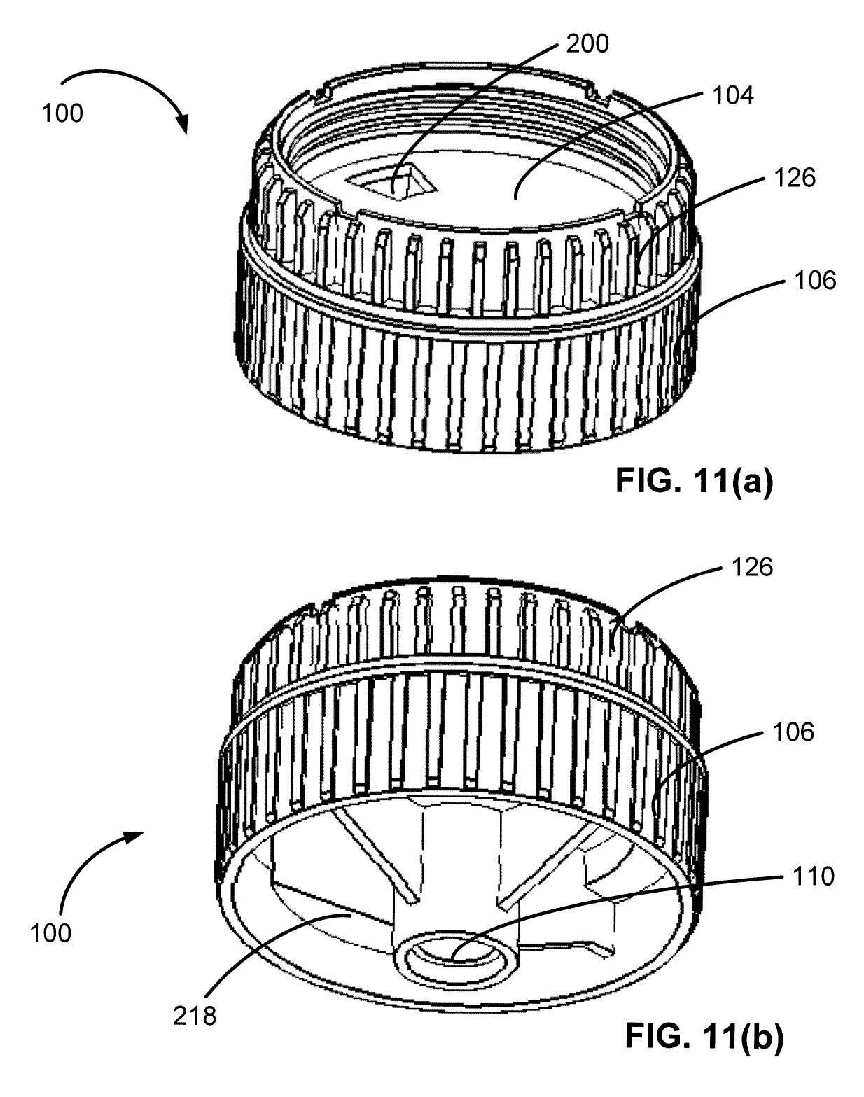

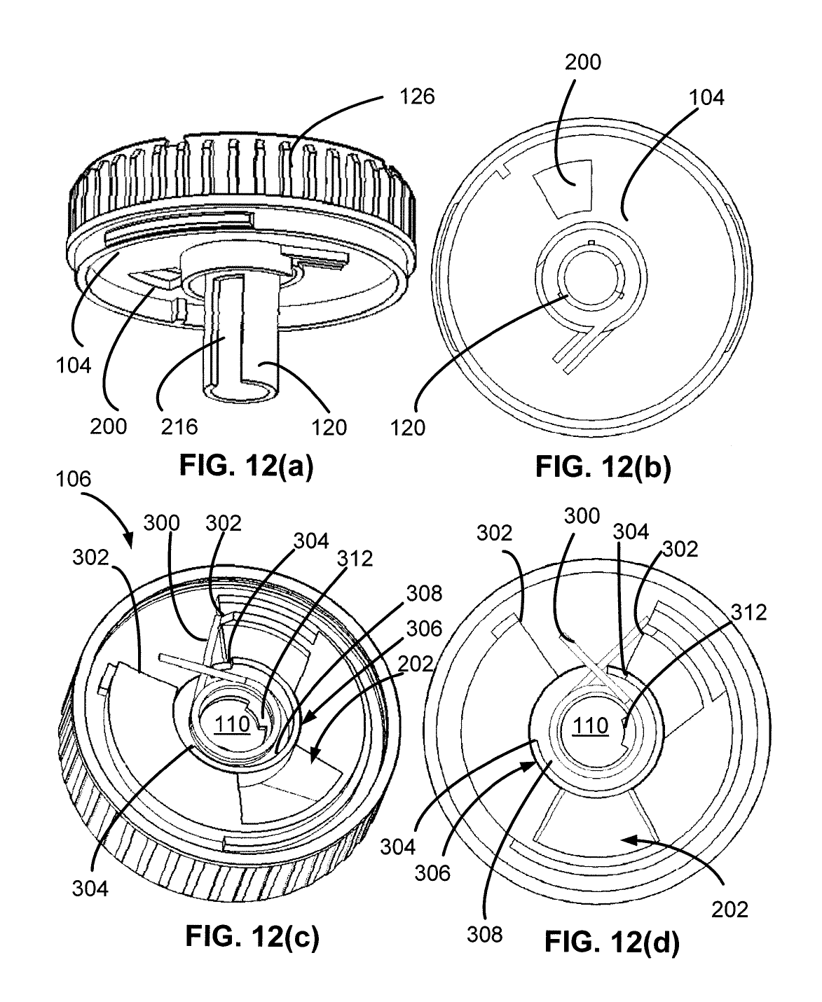

Referring now to FIGS. 11(a), 11(b), and 12(a) to (d), there is shown a fourth embodiment of the dispenser 100. The fourth embodiment is similar to the third embodiment with one functional difference being that the fourth embodiment includes a torsion spring 300 that is wrapped around the doser cover 120 when the dispenser 100 is being used. As discussed in further detail below, the torsion spring 300 is used to return the doser cover 120 to the loading position after a dose of the bulk material is dispensed.

To accommodate the torsion spring 300, the doser 106 in the fourth embodiment has only one of the measuring chambers 202 instead of four of the measuring chambers 202 as in the third embodiment, with a correspondingly smaller slot 200. However, in alternative embodiments (not depicted), more than one of the measuring chambers 202 may be present. As in the third embodiment, rotation of the doser 106 results in the measuring chamber 202 being loaded with the bulk material and, when the open side portion 210 of the measuring chamber 202 eventually aligns with the channel 216 in the doser cover 120, in the bulk material falling out of the measuring chamber 202, through the channel 216, and out of the outlet 110. However, the fourth embodiment includes pairs of spring rotating ridges 302 and spring stopping ridges 304 that collectively operate to torque the spring 300 such that the doser cover 120 consistently returns to the loading position after it has dispensed a dose of the bulk material.

The pair of spring rotating ridges 302 are radially extending strips of plastic that are located on the interior of the doser 106, which in the depicted embodiment are separated by about 50 degrees. As the doser 106 is rotated, one of the rotating ridges 302 is pressed against one of the ends of the torsion spring 300 and rotates the spring 300. Which of the ridges 302 is pressed against the spring 300 depends on which direction the doser 106 is turned.

The pair of spring stopping ridges 304 are part of a cylindrical stopper 306 that is placed within the doser 106 around the outlet 110. The cylindrical stopper 306 has an end face 308 with an opening 310 shaped to receive the doser cover 106. Extending into the opening 310 is a protrusion 312 that is shaped to fit within the channel 216 in the doser cover 120. When the channel 216 is aligned with the protrusion 312 and inserted through the outlet 110, the cylindrical stopper 306 and the doser cover 106 are fixedly coupled together, and the torsion spring 300 is rotatable about the doser cover 106. Extending normal to the end face 308 and parallel to the axis of rotation of the doser 106 is a side wall 314. A channel 316 is cut into the side wall 314, and the edges of the channel 316 act as the spring stopping ridges 304.

As one of the spring rotating ridges 302 pushes one of the ends of the torsion spring 300, the torsion spring 300 rotates relative to the cylindrical stopper 306. Eventually, the other end of the torsion spring 300 is pushed into the spring stopping ridge 304 that is opposite the spring rotating ridge 302 that is applying force to the spring 300. The cylindrical stopper 306 is shaped and positioned so that the torsion spring 300 is twisted when the doser cover 120 is in the dispensing position. Accordingly, when the user lets go of the doser 106, the torsion spring 300 returns to its relaxed position and in so doing returns the doser cover 120 to the loading position. Because the spring rotating and stopping ridges 302, 304 sandwich the ends of the torsion spring 300, regardless of whether the doser 106 is rotated clockwise or counterclockwise the spring 300 will be twisted when the doser cover 120 is in the dispensing position and will return the doser cover 120 to the loading position after the bulk material is dispensed and user lets go of the doser 106.

The bulk material that the dispenser 100 dispenses may be a powder, or any other bulk material that for which the dispenser 100 is suitably sized. For example, by making the inlet 108 and outlet 110 sufficiently large, the dispenser 100 can be configured to dispense bulk materials just as nuts or candy.

While particular embodiments have been described in the foregoing, it is to be understood that other embodiments are possible and are intended to be included herein. For example, while the fourth embodiment uses pairs of the rotating and stopping ridges 302, 304 that allow the doser 106 to be rotated either clockwise or counterclockwise, in alternative embodiments (not shown) only one rotating ridge 302 and one stopping ridge 304, which are positioned to oppose each other, may be used. Additionally, while the depicted third and fourth embodiments show the outlet 110 lying along the dispenser 100's axis of rotation, in alternative embodiments (not depicted) the outlet 110 may be positioned elsewhere. The outlet 110 may, for example, be located along the periphery of the doser 106. It will be clear to any person skilled in the art that modifications of and adjustments to the foregoing embodiments, not shown, are possible.

We claim:

1. A bulk material dispenser for dispensing bulk material contained within a container, the dispenser comprising:
(a) a container cover couplable over an opening in the container, wherein the opening allows access to the interior of the container;
(b) a doser extending through the cover and having an inlet on a side of the cover that faces the interior of the container when the container cover is coupled to the container, and an outlet on a side of the cover that faces away from the interior of the container when the container cover is coupled to the container, wherein the inlet and outlet are communicatively coupled such that substantially all of the bulk material that passes through the cover moves from the inlet to the outlet through the doser; and
(c) a doser cover movable on the doser between loading and dispensing positions, wherein the doser cover leaves the inlet at least partially uncovered and closes the outlet when in the loading position, and leaves the outlet at least partially uncovered and closes the inlet in the dispensing position.

2. A dispenser as claimed in claim 1 wherein the container cover is shaped such that the bulk material is funneled into the inlet of the doser.

3. A dispenser as claimed in claim 2 further comprising:
(a) a doser holder coupled to an attachment point on the doser located farther from the container cover than the inlet; and
(b) a support arm coupling the container cover to the doser holder.

4. A dispenser as claimed in claim 3 wherein the doser cover comprises a sleeve slidable along the length of the doser and between the doser and the support arm, and out of which the outlet extends when the doser cover is in the dispensing position.

5. A dispenser as claimed in claim 4 further comprising an actuator plate coupled to the doser cover, wherein the doser cover extends through the actuator plate and moves along the doser in response to actuation of the actuator plate towards the container cover.

6. A dispenser as claimed in claim 5 wherein the actuator plate is shaped to form an annular region around a portion of the doser cover that is on a side of the actuator plate that faces away from the interior of the container.

7. A dispenser as claimed in claim 6 further comprising a compression spring located between the actuator plate and the container cover and pushed against the container cover by the actuator plate when the actuator plate is actuated.

8. A dispenser as claimed in claim 7 wherein the container cover has an elongated rim circumscribing the container cover that is attachable at one end around the opening in the container.

9. A dispenser as claimed in claim 8 further comprising a retaining collar coupled to an end of the elongated rim opposite the end attachable to the container, wherein the retaining collar comprises a retaining collar flange that supports the actuator plate when the doser cover is in the loading position.

10. A dispenser as claimed in claim 9 further comprising a stability collar circumscribing the actuator plate and slidable within the coupling and retaining collars in response to the actuation of the actuator plate, wherein the support collar rests on the retaining collar flange when the doser cover is in the loading position.

11. A dispenser as claimed in claim 10 wherein the stability collar further comprises an outwardly projecting support ridge on its exterior and wherein the retaining collar further comprises inwardly projecting flutes, and wherein the support ridge rests on the flutes and the flutes guide the support collar within the retaining collar as the doser cover moves between the loading and dispensing positions.

12. A bulk material dispenser for dispensing bulk material contained within a container, the dispenser comprising:
(a) a container cover couplable over an opening in the container, wherein the opening allows access to the interior of the container and wherein the container cover comprises a slot that allows the bulk material contained within the container to pass through the cover when the container cover is coupled over the opening;
(b) a doser rotatably couplable to the container and having a measuring chamber with an open top portion and an open side portion, wherein the open top portion is alignable with the slot such that the bulk material passing from the container and through the slot can enter the measuring chamber through the open top portion; and
(c) a doser cover rotatable relative to the doser between loading and dispensing positions, wherein the doser cover closes the open side portion when in the loading position and leaves the open side portion at least partially uncovered when in the dispensing position.

13. A dispenser as claimed in claim 12 wherein the doser rotates about an axis of rotation, and wherein the open side portion faces the axis of rotation such that the bulk material exiting the measuring chamber through the open side portion travels towards the axis of rotation.

14. A dispenser as claimed in claim 13 wherein the open side portion is shaped as a circular arc whose center is along the axis of rotation.

15. A dispenser as claimed in claim 14 wherein the doser cover is tubular and has a channel in its side, and wherein the channel only overlaps with the open side portion when the doser cover is in the dispensing position.

16. A dispenser as claimed in claim 15 wherein the doser cover is fixedly coupled to the container cover and is inserted through the center of the doser.

17. A dispenser as claimed in claim 16 wherein the doser cover is coaxial with the axis of rotation.

18. A dispenser as claimed in claim 17 wherein the measuring chamber has a bottom portion that is tapered to feed the bulk material from the open top portion to the open side portion.

19. A dispenser as claimed in claim 18 wherein a plurality of measuring chambers are spaced circumferentially around the doser cover such that the doser cover rotates between the loading and dispensing positions for each of the measuring chambers, and wherein the open side portion of each of the measuring chambers is adjacent to the doser cover.

20. A dispenser as claimed in claim 12 further comprising:
(a) a torsion spring wrapped around the doser cover; and
(b) a spring rotating ridge fixedly coupled to one of the doser and doser cover, and a spring stopping ridge fixedly coupled to the other of the doser and doser cover, wherein the spring rotating and stopping ridges are positioned to contact opposite ends of the torsion spring such that the torsion spring is twisted when the doser cover is in the dispensing position and relaxed when the doser cover is in the loading position.

21. A dispenser as claimed in claim 20 wherein the spring rotating ridge is fixedly coupled to the doser and the spring stopping ridge is fixedly coupled to the doser cover.

22. A dispenser as claimed in claim 21 wherein the doser rotates about an axis of rotation, and wherein the open side portion faces the axis of rotation such that the bulk material exiting the measuring chamber through the open side portion travels towards the axis of rotation.

23. A dispenser as claimed in claim 22 wherein the open side portion is shaped as a circular arc whose center is along the axis of rotation.

24. A dispenser as claimed in claim 23 wherein the doser cover is tubular and has a channel in its side, and wherein the channel only overlaps with the open side portion when the doser cover is in the dispensing position.

25. A dispenser as claimed in claim 24 wherein the doser cover is fixedly coupled to the container cover and is inserted through the center of the doser.

26. A dispenser as claimed in claim 25 wherein the doser cover is coaxial with the axis of rotation.

27. A dispenser as claimed in claim 26 wherein the measuring chamber has a bottom portion that is tapered to feed the bulk material from the open top portion to the open side portion.

28. A dispenser as claimed in claim 27 wherein a plurality of measuring chambers are spaced circumferentially around the doser cover such that the doser cover rotates between the loading and dispensing positions for each of the measuring chambers, and wherein the open side portion of each of the measuring chambers is adjacent to the doser cover.

29. A dispenser as claimed in claim 25 wherein the spring stopping ridge comprises part of a cylindrical stopper through which the doser cover is inserted, the cylindrical stopper comprising:
(a) an end face having an opening through which the doser cover is inserted and a protrusion extending into the opening insertable into the slot to prevent relative rotation of the cylindrical stopper and the doser cover; and
(b) a side wall attached to the end face and having a channel whose edges comprise the spring stopping ridge.
